(19) United States
(12) Patent Application Publication
(10) Pub. No.: US 2014/0099617 A1
(43) Pub. Date: Apr. 10, 2014

(54) PATIENT SIMULATION SYSTEM FOR MEDICAL SERVICES OR DIAGNOSTIC MACHINES

(71) Applicant: Richard D. Tallman, JR., Poway, CA (US)

(72) Inventor: Richard D. Tallman, JR., Poway, CA (US)

(21) Appl. No.: 14/051,442

(22) Filed: Oct. 10, 2013

Related U.S. Application Data
(60) Provisional application No. 61/712,250, filed on Oct. 10, 2012.

(51) Int. Cl. G09B 23/28

(52) U.S. Cl. CPC G09B 23/28
USPC 434/262

(57) ABSTRACT

A system, method, and apparatus for a patient simulator that interacts with a diagnostic or therapeutic medical device. The system includes a computing device coupled to a patient module. The patient module includes hydraulic equipment that simulates a baseline fluid interconnection with a therapeutic device. The computing device manages physical and virtual data, provides algorithmic calculations for simulating hypothetical patient vital signs, long-term clinical course, and simulates related fluid properties. The simulation system automatically executes a step-wise clinical scenario, specified in a spreadsheet format of patient conditions and equipment scenarios, that also includes audio/visual stimuli of operating room and diagnostic clinic environments, along with data recording capabilities. The therapeutic device can be a heart lung machine (HLM), an extracorporeal membrane oxygenation (ECMO) machine, an emergency cardiac life support (ECLS) device, a ventricular assist device (VAD), a dialysis machines, a hyperthermic intraperitoneal chemotherapy (HIPEC) machine, and an aortic balloon pump.

### CROSS-REFERENCE TO RELATED APPLICATIONS

This application claims priority to provisional application, U.S. Ser. No. 61/712,250, filed Oct. 10, 2012, entitled “PATIENT SIMULATION SYSTEM FOR MEDICAL SERVICES OR DIAGNOSTIC MACHINES,” which application is also incorporated by reference herein, in its entirety.

### FIELD OF TECHNOLOGY

This disclosure relates generally to the technical fields of medical devices, and in one example embodiment, this disclosure relates to a method, apparatus and system of patient simulation with diagnostic and patient services machines.

### BACKGROUND

This disclosure relates generally to the technical fields of medical devices, and in one example embodiment, this disclosure relates to a method, apparatus and system of patient simulation with diagnostic and patient services machines.

A patient simulator (e.g., a simulation apparatus) may be used in the training of health-care students (e.g., pharmacy students, nursing students, medical students). The patient simulator may provide insight and experience without the associated risks associated with on-the-job training with actual patients. However, the patient simulator may be limited in its ability to simulate a range of possible medical conditions. As a result, the medical simulator may not be usable in a wide range of medical training.

One type of the patient simulator may be implemented substantially in software. Using a graphical user interface (GUI) and software programming, the patient simulator implemented substantially in software may only provide limited insight into an actual patient care scenario because of its partial approximation of a real-world physical interaction. Further, a simulation conducted substantially in software may lack depth given that the simulated experience may not adequately model external stressors (e.g., presence of blood, screaming patients, multiple complications among different patients simultaneously). Therefore, the patient simulator implemented solely in software may not adequately prepare the health care students for actual patient care scenarios in the physical world. This lack of preparation can result in errors, omissions, and sometimes a loss of life.

### SUMMARY

A hydraulic based, hardware and software simulation system which models a human patient and attaches to any of a variety of extracorporeal cardiopulmonary support devices such as a heart lung machine (HLM), extracorporeal membrane oxygenation (ECMO) machine, emergency cardiac life support (ECLS) device, ventricular assist device (VAD), dialysis machines, hyperthermic intraperitoneal chemotherapy (HIPEC) machine, Aortic Balloon pump etc.

The system uses proprietary models of the cardiovascular system, the respiratory system, the gas exchanged by an artificial lung, and drug interactions and combines them into a realistic and reactive model of the human body.

The models in the system are combined with the appropriate sensors and actuators to detect and react appropriately to the impacts imposed by the various extracorporeal cardiopulmonary support devices on the human body. These reactions include the dynamic and long-term impact on the cardiovascular system, the respiratory system, the hematological system, and the renal system.

The patient reactions or changes are displayed on a variety of ‘virtual’ operating room (O.R.) and ICU monitors that are part of the simulator. Displays include signals from singular systems or any combination of signals from systems such as a pulse oximeter, a cerebral oximeter, an in-line blood gas monitor, a blood gas analyzer, an activated clotting time (ACT) analyzer, EKG monitor, a blood pressure monitor, or bispectral index (BIS) cerebral monitor.

A predetermined clinical scenario is used to control the virtual patient by displaying of appropriate monitors, providing verbal commands and alerts, displaying and manipulating the O.R. clock, and providing for the sequence of events that make a realistic therapeutic or operating room environment. This scenario can be pre-established and loaded into the simulator using a single spreadsheet file.

Configuration of the patient simulator is accomplished with predetermined clinical scenarios. It comprises displaying the appropriate monitors available, choice of verbal commands and alerts, O.R. clock manipulation, and sequencing of events. These custom clinical scenarios can be pre-established and loaded into the patient simulator using a single spreadsheet. The user or operator (trainer) has the option to write custom scenarios for the trainee and can apply clinical data including arterial pressure, pulmonary artery pressure, EKG-including multiple arrhythmias, ventilator, A.C.T. Plus, arterial color duplex imaging (CDI), venous CDI, blood monitoring unit (BMU), spectrum medical variable input patient electronic record, HMS, blood gas analyzer, and NIRS. In addition, patient-specific factors (sex, height, weight, body surface area (BSA)), physiologic factors including left ventricular (LV) and right ventricular (RV) contractility, heart rate, depth of anesthesia and metabolic rate can all be included in the clinical scenario.

The system maintains an electronic medical record that can be saved and accessed during or after the simulator system exercise for a given clinical scenario. This medical record contains all of the time-stamped information relevant to the case including patient vital signs, medications given and special events and circumstances. In addition, this electronic medical record can be sent out in real time to various data management systems (DMSs) designed to collect and maintain clinical data during surgical cases. This is accomplished by communication via the serial port of the computing device using standard communication protocols.

The methods, operations, processes, systems, and apparatuses disclosed herein may be implemented in any means for achieving various aspects, and may be executed in a form of a machine-readable medium, and/or a machine accessible medium, embodying a set of instructions that, when executed by a machine or a data processing system (e.g., a computer system), in one or more different sequences, cause the machine to perform any of the operations disclosed herein. Other features will be apparent from the accompanying drawings and from the detailed description that follows. Accordingly, the specification and drawings are to be regarded in an illustrative rather than a restrictive sense.

### BRIEF DESCRIPTION OF THE DRAWINGS

Example embodiments are illustrated by way of example and not limitation in the figures of the accompanying drawings, in which like references indicate similar elements and in which:

FIG. 1 is a diagram of a medical simulation system coupled to one or more therapeutic devices, according to one or more embodiments.

FIG. 2A is a block diagram of the functional inputs and outputs of the simulation system, according to one or more embodiments.

FIG. 2B is a block diagram of the functional inputs and outputs of the simulation module portion of the simulation system, according to one or more embodiments.

FIG. 3 is a schematic of the patient module, according to one or more embodiments.

FIG. 4 is a display of the patient monitor/delivery device, according to one or more embodiments.

FIG. 5A is a graphical user interface (GUI) of the simulation module for a heart-lung machine (HLM), as shown on the instructor display, according to one or more embodiments.

FIG. 5B is a graphical user interface (GUI) of the simulation module for an extracorporeal membrane oxygenation (ECMO), as shown on the instructor display, according to one or more embodiments.

FIG. 6 is a clinical scenario spreadsheet, according to one or more embodiments

FIG. 7 is a flowchart of a process simulating a patient interaction with a therapeutic machine, according to one or more embodiments.

Other features of the present embodiments will be apparent from the accompanying drawings and from the detailed description that follows.

### DETAILED DESCRIPTION

A method, apparatus and system of patient simulation for medical services and diagnostic machines is disclosed. In the following description, for the purposes of explanation, numerous specific details are set forth in order to provide a thorough understanding of the various embodiments. It will be evident, however to one skilled in the art that various embodiments may be practiced without these specific details.

### Patient Simulator

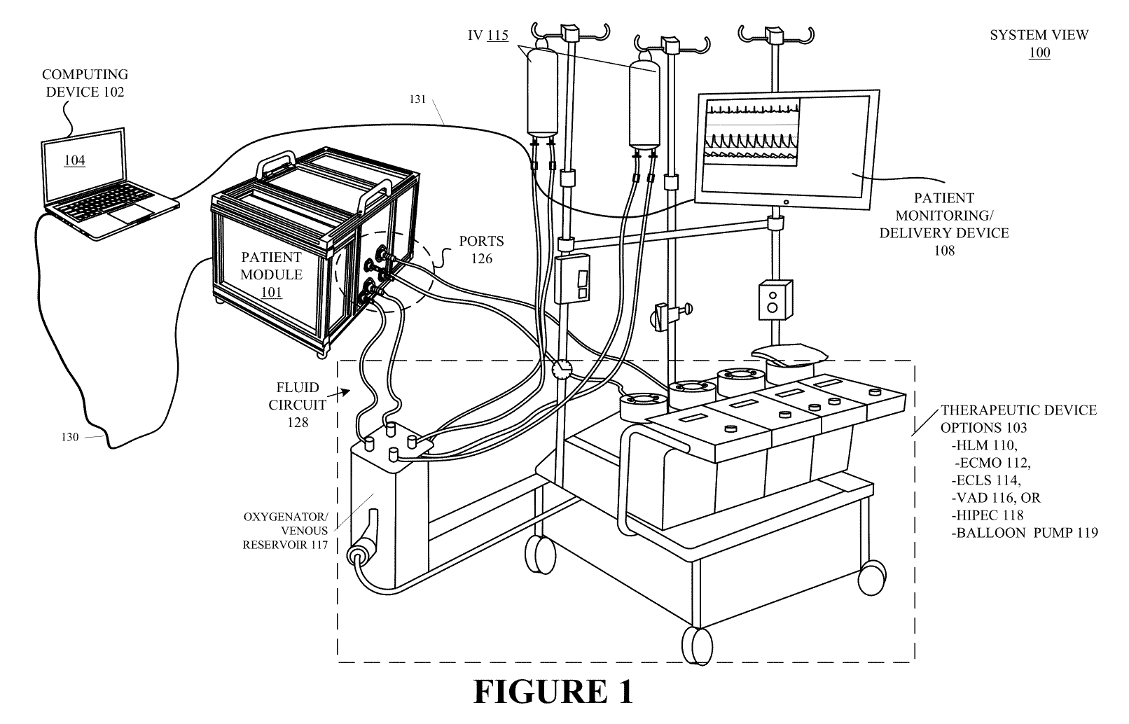

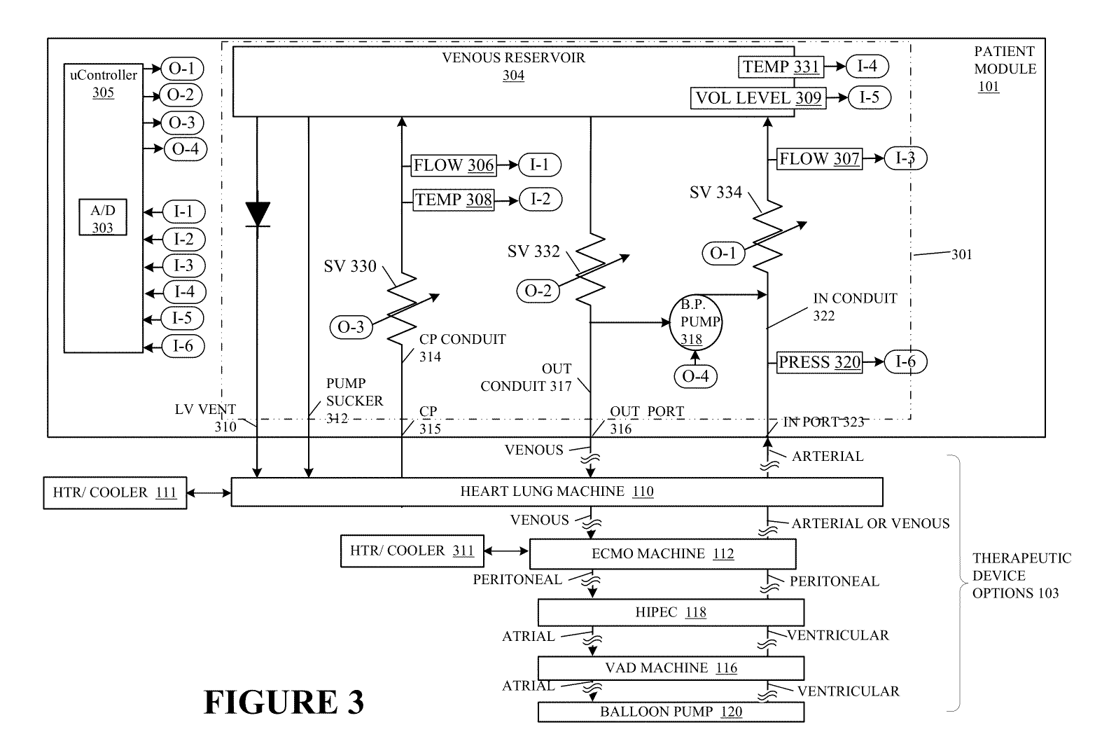

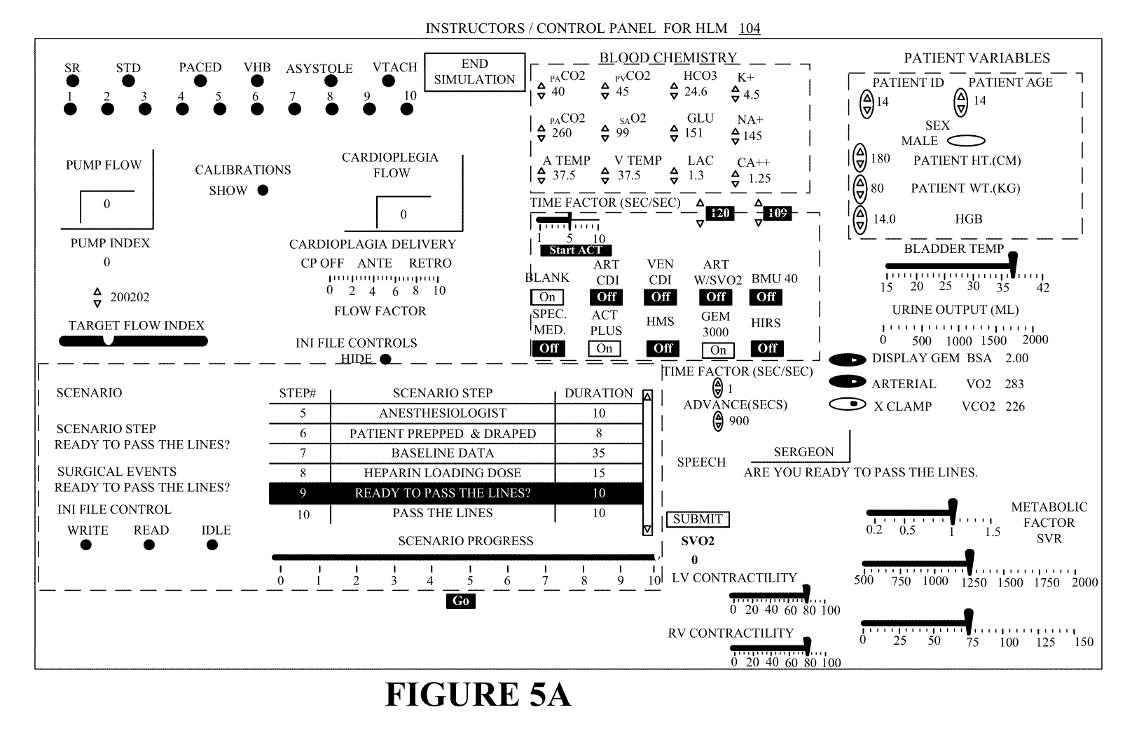

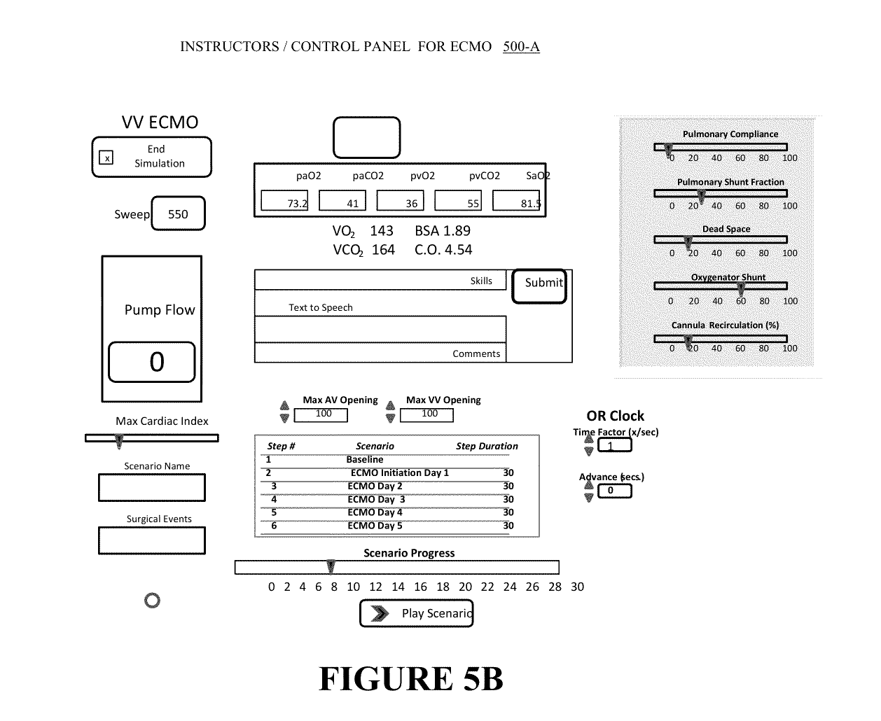

Referring to FIG. 1, a medical simulation system 100 coupled to one or more therapeutic device options 103 is shown, accordance with one or more embodiments. Medical simulation system 100 includes a patient module 101 that represents a body of a patient, electrically coupled to a computing device 102. Patient module 101 contains a fluid circuit, input and output ports, fluid sensors, and control devices, as described in more detail in subsequent FIG. 3. Computing device 102 implements one or more algorithms to simulate and/or evaluate vital signs of the patient module 101 during an execution of a clinical scenario. A graphical user interface (GUI) on instructor display 104 shows simulation system options, clinical scenario results, etc. thereby allowing the instructor to control and manipulate the simulation, as described in more detail in FIGS. 5A-5B.

A patient monitor/delivery device 108 performs many functions as well, such as displaying physical data that was measured in patient module 101 and at least a portion of the clinical scenario. Furthermore, patient monitor/delivery device 108 displays virtual data calculated by an algorithm in computing device 102, to which it is coupled, as well as clinical scenario data read from memory in computing device. Patient monitor/delivery device 108 also accepts input from a system operator, or user, who is being trained as a clinician on the simulation system 100, and who can select virtual control data for virtual portions of therapeutic devices or for an entire therapeutic device and communicate that virtual data back to computing device 102. For example, patient monitor/delivery device 108 can display an oxygen (O2) blood level of the patient, or receive a clinician's input to increase a virtual control of O2 delivery to the ECMO machine 112. In combination with the clinician physically changing a blood flow rate setting on the actual ECMO machine 112 itself, a resulting increase of the patient module blood level is shown as increased on the same display, with the blood level calculation being performed by the computing device 102. Patient monitor/delivery device 108 also provides audio/visual (A/V) training materials during the clinical scenario to simulate a real-life surgical operation or other hospital setting in which the therapeutic device could be used. Consequently, a display function is implemented as well as a delivery function of virtual controls and drug and diagnostic testing by patient display/delivery device. Alternatively, separate discrete screens can be provided for each function.

Both the patient module 101 and computing device 102 of simulation system 100 are flexibly designed to interface with a plurality of extracorporeal therapeutic device options 103, including standalone HLM machine 110, ECMO machine 112, ECLS 114, VAD machine 116, HIPEC 118 and balloon pump 119 (only HLM shown) directly via an external fluid circuit 128 and indirectly via an electrical coupling 130, e.g., a 10/100 Base-T Cat 5 cable. Patient module 101 has a set of input and output ports 126 and internal components packaged in a small form factor aluminum housing (400 mm×330 mm×280 mm, for example) that is easily transported and substantially rugged, with a fast set-up time that supports any of the therapeutic device options 103. Computing device 102 has a superset of programming capability to be selectively implemented for a chosen one of the therapeutic device options 103. Peripheral patient support, such as IV equipment 115 and oxygenator/venous reservoir 117, couple to the simulation system 100 to manage fluid supplies realistically. Thus, compared to a medical simulator that is designed to couple only to a single specific therapeutic device, the present embodiment has much greater flexibility and usefulness, thereby reducing cost, and increasing training effectiveness.

Patient module 101 provides basic core fluid functions (e.g., arterial flow rate and pressure) for realistic fluid coupling to therapeutic devices, while computing device 102 provides any additional fluid functionality (e.g., related central venous pressure (CVP), etc.) and simulating of patient vital sign (such as EKG, blood pH level, etc.) via software. This allows much greater flexibility of the simulation system 100 to interface with any of a wide variety of therapeutic device options 103. Consequently, simulation system 100 provides a holistic simulation vehicle for cost-effectively training clinicians. Physical material, e.g., fluid, is communicated between patient module 101 and the therapeutic device options 103. Signals from computing device 102 are used to control physical components in the patient module 101, such as a stepper valve. Physical data, such as fluid pressure, is communicated from patient module 101 to computing device 102.

In one embodiment, a comma-separated values (CSV) electronic document, e.g. a spreadsheet, dictates the clinical scenario, with field-separated columns for over 50 physiological and monitoring variables in a practically unlimited number of sequential steps, represented by at least one line of data. The spreadsheet is read by the computing device, and evaluated by the algorithmic application software in combination with the measured fluid data, and the virtually selected variable to provide the simulated patient vital signs and long-term clinical course. A virtually selected variable is a variable or a setting that a clinician sets via the patient monitor/delivery device 108 that is used by computing device 102 to algorithmically calculate a related, but not physically measured, patient parameter, such as pulmonary artery blood pressure.

### Functional Control Plane

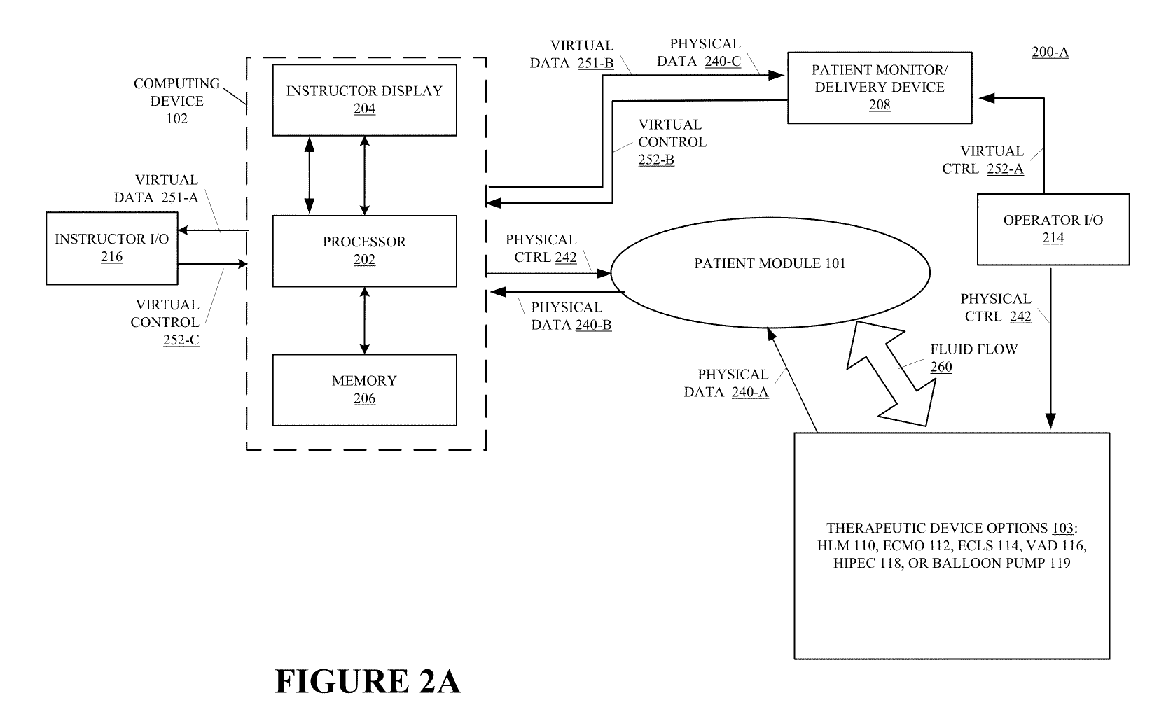

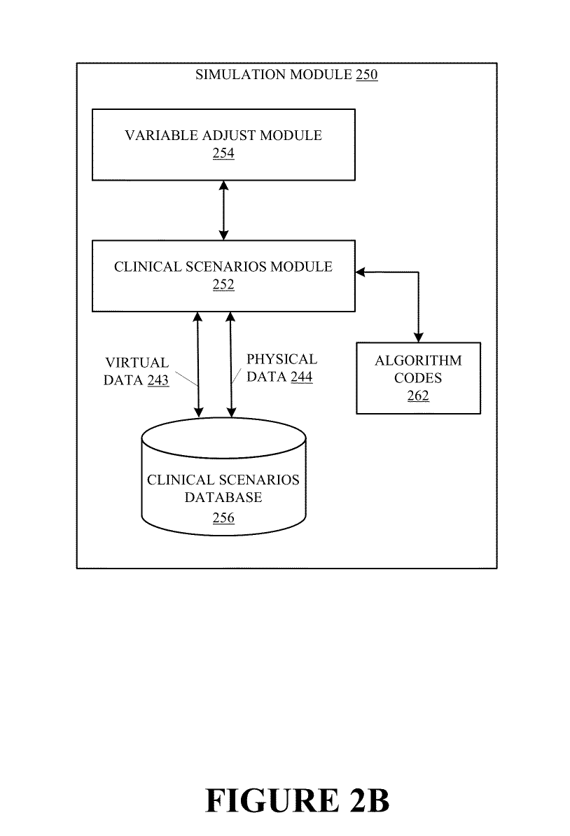

Referring now to FIG. 2A, a block diagram 200-A of the functional inputs and outputs of the simulation system is shown, according to one or more embodiments. Computing device 102 includes a processor 202 coupled to memory 206 to receive physical data 240-B from the patient module and to implement one or more algorithms to simulate vital signs of a hypothetical patient simulated by the patient module 101 during an execution of a clinical scenario. In one embodiment, physical data includes fluid pressure and flow rates, as described in FIG. 3.

Instructor display 204 illustrates data related to the clinical scenario. Instructor I/O 216 is any communication device and connection such as a keyboard, mouse, touch screen, wireless device, network connection for remote access, etc., to share data between an instructor and computing device 102. Physical control is provided from computing device 102 to patient module 101 to implement clinical scenario conditions, e.g., a venous stepper valve is closed in response to a clinical scenario condition of a patient bleeding out. Operator I/O 214 implements physical control input 242 to therapeutic device options 103 by manually touching their controls. Operator I/O 214 also implements virtual control of therapeutic device options 103 via virtual control input 252-A to patient monitor/delivery device 208 and propagated virtual control input 252-B to computing device 102. This effectuates a change by operator I/O 214 by algorithmically calculating the effect on patient vital signs and long term clinical care, and passing that resulting virtual data back to patient monitor/delivery device 208 via virtual data 251-B and to instructor display as virtual data 251-A. Thus, a clinician may selectively choose a drug delivery option in a GUI displayed on the touch screen of the patient monitor/delivery device 108. That selection would be communicated to computing device 102 that would then algorithmically consider the input when evaluating other variables to determine the vital signs that the computing device will simulate and then display on the patient monitor/delivery device 108.

Physical data 240-A, e.g., flow, pressure, and temperature, is communicated from therapeutic device options 103 via the fluid transfer. Physical data 240-B is communicated from patient module 101 to computing device 102 by virtue of fluid sensors in patient module 101, and is read by computing device 102. The clinical scenarios and parameters can be recorded directly to memory 206, at a desired sampling rate, or to a printer (not shown) in response to a touch screen request by instructor I/O 216 or operator/clinician I/O 214. Simulation system 100 also has an ability to add different types and sizes of flow sensors to accommodate a wide range of simulated patient sizes.

Referring now to FIG. 2B, a block diagram 200-B shows the functional inputs and outputs of the simulation module 250 portion of the simulation system 100 is shown, according to one or more embodiments. Simulation module 250 is implemented in computing device 102 by storing clinical scenario database 256 and algorithm codes 262 in memory 206 and by accessing and executing same using processor 202. Inputs to simulation module 250 include physical data 240-B from patient module 101, virtual control 252-B from patient monitor/delivery device 208, and instructor I/O 216, as shown in FIG. 2A. Both virtual data 251 and physical data 240 are stored and retrieved from clinical scenarios database 256 during the execution of the clinical scenario.

Referring now to FIG. 3, a schematic of the patient module 101 is shown, according to one or more embodiments. Patient module 101 includes a fluid circuit 301 and includes a microcontroller 305, coupled to each other for simulating a hydraulic function of a hypothetical patient as shown in the simulation system 100 of FIG. 1. Fluid circuit 301 contains conduits, sensors, and control devices coupled to each other. In particular, fluid circuit 301 includes an input (IN) conduit, or line, 322 having an input port 323, a pressure transducer 320 for sensing input pressure, a variable stepper motor proportioning valve (stepper valve or SV) 334, shown as a variable resistance symbol, for varying the resistance on the input conduit, or line, 322 per the clinical scenario, and a flow meter 307 for measuring a flow rate of fluid in the input conduit 322. Similarly, fluid circuit 301 includes an output (OUT) conduit, or line, 317 having an output port 316, and a variable stepper motor proportioning valve 332 for varying the flow restriction, or resistance, on the output conduit 317 per the clinical scenario. An additional input conduit is provided with cardiopulmonary (CP) input conduit 314 having a CP port 315, a variable stepper motor proportioning valve (SV) 330 for varying the resistance on the CP conduit 314 line per the clinical scenario, a flow meter (FLOW) 306 for measuring a flow rate of fluid in the CP conduit 314, and a temperature sensor 308 for measuring temperature (TEMP) of fluid in CP conduit 314. Two additional lines are provided as a pump sucker 312, which provides suction of blood from fluid circuit 301 similar to that used by a surgeon to remove blood from the chest cavity during heart surgery, and a vent 310, which allows for the purging of air from the fluid circuit 301. All these described lines and conduits are disposed parallel to each other from the ports to the venous reservoir 304, to which they are appropriately coupled. Input ports 323, 316, 315 and ports for pump sucker 312 and vent 310, are shown in FIG. 1 as ports 126. The specific function and settings of the valves and the impact of the sensors in the fluid circuit 301 are described hereinafter, based upon which of the therapeutic device options 103 is coupled to the patient module 101. The variable stepper motor proportioning valves 330, 332, and 334 can have a flow rate over a range from about 50 ml/min for a neonate to about 6.5 L/min for an adult.

A blood pressure (B.P.) pump 318, implemented as a positive displacement roller pump, couples output conduit 317 with input conduit 322 to provide a baseline heartbeat and pressure in input conduit 322 for initial coupling of patient module 101 to a therapeutic device, as part of the protocol for establishing a connection between and confirming the connection with a heartbeat and pressure. That is, some therapeutic machines check for a patient pulse prior to initiating treatment. The speed of the pulsating B.P. pump 318 matches the patient heart rate as dictated by the clinical scenario. The volume of the venous reservoir 304 can be adjusted to accommodate different patient sizes by manually inserting a displacement object inside the reservoir or by adjusting the volume (VOL) level sensor 309 such that the threshold level is lower for a smaller size patient. Temperature sensor 331 provides temperature reading for the fluid in the venous reservoir 304. The fluid sensors for flow 307, pressure 320 and resistance 334 of the fluid flow in input conduit 322 is common to HLM 110, ECMO machine 112, VAD machine 116, and aortic balloon pump 119 since all these therapeutic devices access blood and are concerned with measuring pressures and flows and modeling the body to show responses to different protocols and devices that affect the pressure and flow.

Variable resistance symbol represent variable pressure drops in fluid conduit between patient and heart lung machine to simulate a pinched or occluded catheter, or a catheter pressed against the wall of the heart or vessel that can stop or restrict the blood flow. The variable pressure drop can be accomplished by any mechanical means of restricting the effective diameter of the tubing. For example, stepper motor valve 334 can be controlled by feedback from the pressure transducer 320 and thereby be used to maintain the blood pressure to match the readout in the algorithmic model and on the ICU monitor.

Therapeutic device options 103 include any one of the HLM 110, ECMO machine 112, HIPEC 118, VAD machine 116, and balloon pump 119 are all selectively coupled to input port 323 and output port 316 as the two common fluid ports of patient module 101 that apply to each of the therapeutic device options 103. Note that input conduit 322 and output conduit 317 are referred to generally as ‘input’ and ‘output’ because the specific human blood vessels they represent are different from each other. For example, for the HLM 110, input conduit 322 represents an arterial blood vessel, while output conduit 317 represents a venous blood vessel. In contrast, for the ECMO machine 112, input conduit 322 represents an arterial or venous blood vessel, while output conduit 317 represents a venous blood vessel. This embodiment for ECMO allows a different simulated blood path of venous out/venous in (VV) or venous out/arterial in (VA) to the patient module 101 without any plumbing hardware changes in the fluid circuit 301. As another example, for the HIPEC machine 118, input conduit 322 represents an input to the peritoneal cavity, while output conduit 317 represents an output to the peritoneal cavity. In contrast, for the VAD machine 116 and balloon pump 119, input conduit 322 represents a ventricular blood vessel, while output conduit 317 represents an atrial blood vessel. Just as input line 322 and output line 317 can be configured and labeled to represent different blood vessels in the body, so can stepper valves be configured and labeled to represent different functions and settings, depending upon the therapeutic device option chosen and the clinical scenario operated on the simulation system. For example, stepper valve 334 provides the resistance in the arterial (input) line 322 to maintain an arterial blood pressure reading 320 at the pressure indicated on the patient display/delivery device 108, described hereinafter. This arterial blood pressure is determined by several factors dictated by the clinical scenario including the patient size, clinical pathology and blood flow 306 generated by the heart lung machine 110 or ECMO machine 112. Likewise, stepper valve 332 controls the rate of blood drainage from the patient through the venous drain. Partially closing valve 332 will result in an accumulation of blood in reservoir 304 with the concomitant increase in the patient's simulated blood volume and reflex alterations in blood pressure, etc.

The flexibility of patient module 101 arises from, in part, tracking and labeling the inputs to and outputs from microcontroller 305, which are subsequently communicated to computing device 102, according to an identified one of the therapeutic device options 103 utilized in the clinical scenario. Thus, for HLM simulation, pressure 320 and flow meter 307 sensor outputs are labeled and evaluated in the clinical scenario as ‘arterial’ blood vessel values, while the same sensor outputs are labeled and evaluated in the clinical scenario as ‘peritoneal’ fluid values for a HIPEC simulation. Optional heater (HTR)/cooler 311 is coupled to the HLM 110 and the ECMO machine 112 for improved features in the clinical scenario. The HLM 110 requires additional plumbing that is provided in patient module 101 as pump sucker 312 and LV vent line 310, which are included in the superset of fluid conduits 301 to as to provide the universal application to therapeutic device options 103.

Microcontroller (uController) 305 interfaces multiple input lines (I-1 through I-6), for sensing input values, and multiple output lines (O-1 through O-4), for controlling the different control devices, via an analog to digital (A/D) converter 303. In particular, inputs to uController 305 include CP flow meter 306 input I-1, CP temperature 308 input I-2, input conduit flow meter 307 input I-3, venous reservoir temperature 309 input I-4, venous reservoir level 309 input I-5, and input conduit pressure 320 as input I-6. In particular, outputs from uController 305 include input conduit stepper valve 334 as output O-1, output conduit stepper valve 322 as output O-2, CP stepper valve 330 as output O-3, B.P. pump 318 control as output O-4. Microcontroller 305 includes programmability functions with memory for storing firmware or software, e.g., on EEPROM, such that microcontroller 305 can behave ‘reflexively’ to conditions sensed in patient module 101. Thus, for example, if volume level sensor 309 input I-5 reaches a low threshold, i.e. an indication that the patient is bleeding out, then uController 305 reads that low threshold value, and outputs a signal to close CP conduit stepper valve 330, thereby maintaining fluid in patient module 101 and avoiding a dry operation, while indicating to a HLM 110, via the pumped fluid, that a problem exists.

Microcontroller 305 is a real-time and modular embedded control system that, in one embodiment, includes a processor, FPGA, 512 MB built in memory, and ten slots for modules, all coupled to each other. Available modules include analog I/O, industrial digital I/O, TTL I/O, reed relays, RTDs, SSRs, stepper driver and other control functionality. The simulator software takes the sensor readings and uses them as input into the physiological algorithms to generate the patient's responses and drive the O.R. monitor. Scenario actions that require mechanical responses will drive the uController 305 to control the pump and stepper valves as shown in FIG. 3. While the specific embodiment is provided herein for microcontroller 305, those skilled in the art appreciate that a wide variety of computing devices can be utilized to provide the control and computations needed in patient module 101.

Microcontroller 305 is coupled to computing device 102 via the A/D converter module 303 such that data from the patient module 101, e.g., bypass blood flow rate, cardioplegia flow and circulating blood volume, is communicated to computing device 102 and combined with data from sensors and actuators to detect and react appropriately to the inputs imposed by the various extracorporeal and cardiopulmonary support devices on the human body. These reactions include the dynamic and long-term impact on the cardiovascular system, the respiratory system, the hematological system, and the renal system.

Still referring to FIG. 3, an IV fluids drip bag (shown 115 in FIG. 1) is coupleable to patient module 101 directly (not shown), or indirectly via reservoir 117, for the clinician to administer additional fluid. This is included as part of the simulation because adding fluid is a common treatment used to increase the circulating blood volume of the patient. This will greatly affect the blood pressure and cardiac output. Patient module 101 can sense any fluid administration by measuring changes in the venous reservoir volume via a level sensor 309. If the clinician administers more volume from the IV bag (for example in response to a falling blood pressure as dictated by the clinical scenario), the simulator will respond with an appropriate increase in the algorithmically generated virtual value of central venous pressure (CVP) as well as an increase in blood pressure 320 resulting in an increase in algorithmically generated cardiac output and algorithmically generated mixed venous O2 saturation (SVO2). (See FIG. 5A, bottom middle)

The HLM 110 and the ECMO machine 112, as well as the HIPEC machine 118, VAD machine 116, and aortic balloon pump 119, can be standard hospital equipment to which a patient would be coupled, e.g., by tubing that represents blood flow from the patient's artery and vein to the input and output of the Heart/Lung machine (HLM) and/or ECMO machines (ECMOM). No electrical connections are required between the patient simulators and the hospital machines in the present embodiment. However, in another embodiment, sensors can be placed on the patient module, e.g., to measure a patient's temperature, blood pressure, blood O2 rate, etc. The readouts from those sensors can be fed to diagnostic and therapeutic machines 103 or those mentioned in the next section, to provide input and feedback, and more realistically represent a patient's interaction with the machines. By replacing the patient with the patient module 101, different patient scenarios and responses can be presented to the clinician, with the clinician's input and changes being accurately represented therein. The hardware portion of the patient module 101 provides controlled temperature, fluid flow rates or blockages, modulated pressure, pressure spikes or pressure drops, and accurate volumetric representation of a human cardio pulmonary system via the uController 305 and/or the computing device 102 controlling the valves and pump in the patient module 101. The interaction of the software models and the hardware and measurement and metrics input to the software model to allow the simulation system to simulate patient treatments and responses. Some patient treatments are provided as virtual interfaces with the diagnostic/treatment machines, e.g., communicated on link 131 and displayed on patient monitor/delivery device 108 via computing device 102 software algorithm and model for the delivery of drugs, reaction to drugs, contraindications, etc. in response to an operator's selection of type of drug, quantity of drug, and rate of delivery. Other patient conditions such as activated clotting time (ACT), heparin resistance, elevation of blood pressure, heart failure. pathologies, etc. can be programmed with variety of degrees of cardiovascular disease and representative equipment malfunction, simulated ventilator performance for controlling O2 and CO2, etc., while simulating the patient transition on or off the ECMO machine as would be done clinically.

The hydraulic portion of the patient module 101 simulates the blood flow between the ECMO machine 112 and the patient. That is, patient module 101, via an interactive system, pumps fluid (e.g., colored water to simulate blood) between patient module 101 and any of the therapeutic machine options 103. This simulation provides a more life-like representation of the interaction between the three primary interactions in patient treatment: i) between a patient and the ECMO or CPB machine, ii) between the operator and the patient, e.g., delivering drugs, and iii) between the operator and the ECMO machine, e.g., modifying controls of the ECMO machine. Thus, the present system provides a full bidirectional communication, interaction, and feedback between the three primary components of the system. Any combination or permutation of conditions and reactions between the three primary interactions can be provided as desired by the programming steps provided hereinafter.

Patient module 101 may be selectively operated in multiple modes, including a real mode or in a simulation mode. In the real mode, computing device 102 interacts with the patient module 101 to evaluate at least one fluid property measured and to provide a signal to the at least one control device disposed. In the simulated mode, no interaction exists between patient module 101 and computing device 102, with computing device 102 calculating all data for patient module 101. In a hybrid mode, the patient module 101 measures flow and volume, and models patient responses (with proprietary physiological models that simulate responses), but with no feedback, no valves, etc. that would measure the interaction with the ECMO machine 112. In this mode, the patient attributes can be modeled in the patient module 101, e.g., sicker patient, recovering patient, an acute condition or crashing patient, etc. This baseline patient module 101 is a cost-effective tool for new trainees. Features can be manually performed on this baseline patient module 101, such as manually closing off a hose, to simulate a kink in the catheter.

However, as competence grows, a trainee should transition to another embodiment of the patient module 101 that does provide an output and does receive an input (feedback) that measures and receives changes to the patient module 101. This ‘smart’ ECMO patient module provides more life-like responses and interactions that would prepare a clinician for the complications that frequently arise in treating real patients.

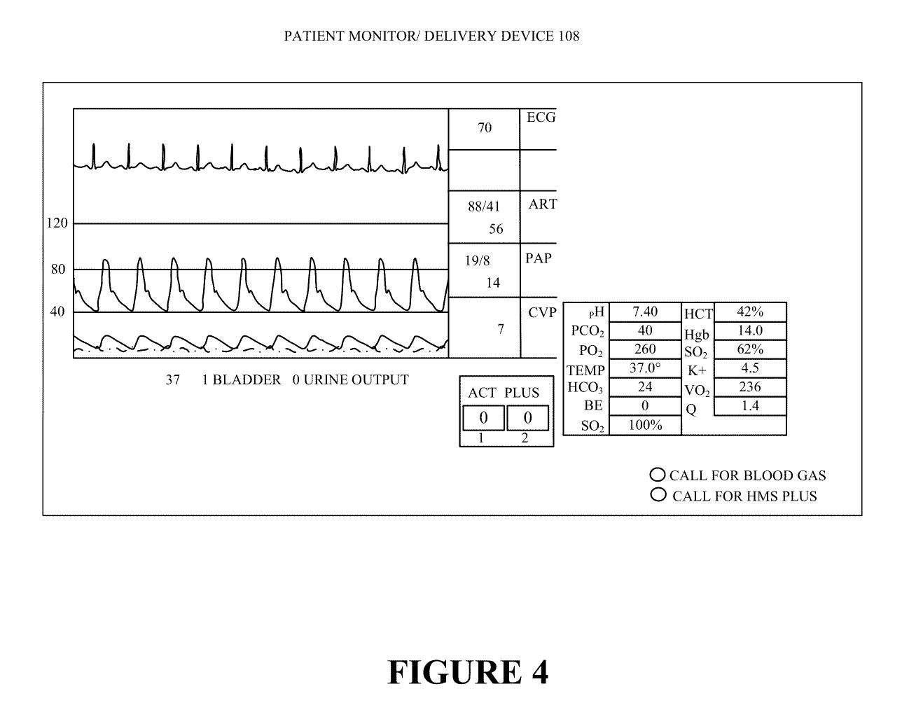

Referring to FIG. 4, a schematic diagram of the patient monitor/delivery device 108 in ECMO mode is shown according to one or more embodiments. The balance of simulator system 100 interactively interfaces with the patient module 101, one or more diagnostic or patient therapeutic machine options 103, and simulated (virtual) physiological systems such as drug administration, (together “components”) and the settings, operator changes to the settings, instructor changes, the components, responses from the components, in a single integrated system. Fluid is pumped between the ECMO machine 112 and the patient module 101 while flow rates and volumes are being measured for compliance to acceptable standards using flow meter 307 and volume level 309. Oxygenation generation and CO2 removal are simulated by computing device 102 for ECMO machine 112 using modeling algorithms that the operator can manipulate via the touch screen of the patient monitor/delivery device 108. Real-time feedback, programmable patient parameters and scenario settings, instructor overrides and modifications provide a nearly indefinite number of testing scenarios through which competent technologists can be trained.

In particular, the simulator system can simulate blood clotting properties and three concurrent blood gasses (pre-Oxygenator, Post-oxygenator, and patient blood gasses, arterial and venous). It can provide full interaction between all four properties to track and model how a change in one or more properties will affect the other properties. It can also model how cardiovascular changes arise, and how pulmonary functions interact with a fluid pump in ECMO machine 112 and ventilator simulator and algorithmically defined patient condition provided by computing device 102. While a default set of algorithms are presented for simulation system 100 in the present embodiment, a user can programmably enter different algorithm formulas, weighting values, and settings for an alternative configuration.

An optional ancillary O.R. monitor (not shown), besides showing typical cardiovascular parameters, can also display any of several ancillary O.R. monitor functions such as the ACT machine, in-line blood gas monitors or outputs from various point of care (POC) devices such as blood gas analyzers or heparin management system (HMS) printouts. Which ancillary monitors are used and when they are visible during the case can all be controlled using simulator GUI via instructor display 104. Any of several different electrocardiogram (EKG) patterns can also be displayed including sequentially advancing to an arrest EKG pattern upon sensing adequate delivery of cardioplegia. Using a touch screen, the operator can administer drugs, print strip charts of lab data generated by the simulator, and make adjustments in gas flow and fraction of inspired oxygen (FIO2) of the CPB sweep gas.

### Controller Display

Referring now to FIG. 5A, a controller display 104 is shown according to one or more embodiments. The instructor display 104 serves as the “controller display” GUI to be used by the instructor or simulation operator. This panel allows the operator to manipulate various physiological parameters related to the patient, change the types of monitors displayed on the O.R. monitor screen as well as control the progress of the clinical scenario.

The proprietary software of simulator system 100 is very customizable which allows the trainer to write custom clinical scenarios for the trainee. Examples of diagnostic and patient-servicing machines include blood pressure monitors, EKG monitors, ventilators, Activated Clotting Time (ACT in-line blood monitoring systems, pulse oximeters, spectrum variable input patient electronic record display, homeostasis management system (HMS), blood gas analyzer, and cerebral oximetry (NIRS). Inputs from these machines can be fed to the simulator CPU via data cable. Alternatively, the data can be communicated in a table format, e.g., in a spreadsheet format, that is usable by the system and software.

Data from any of the aforementioned sources can be modeled and presented on the display for the operator and instructors as an additional or alternative O.R. display parameter. For example, channels or parameters can be shown on the O.R. monitor for bispectral index “BSI” or thromboselastogram (“TEG”), and a variety of different Lab diagnostic printouts.

Patient specific factors (sex, height, weight), physiologic factors including left ventricle (LV) and right ventricle (RV) contractility, heart rate, pulmonary functions (pulmonary compliance, shunt fraction, dead space) depth of anesthesia and metabolic rate can all be specified through the scenario or by the controller display. By adjusting these factors, pre-existing co-morbidities can be simulated and actual patient physiology can be controlled according to temperature and drug load.

### Clinical Scenarios

Clinical scenarios in the present disclosure can be preloaded and called up and applied in a variety of timings, stop/start on command, printed out on a local device or stored on electronic or medical data storage devices, such as a USB drive, a network drive, or memory 206 of FIG. 2A. Other clinical monitors and analyzers can be shown on the patient monitor/delivery device 108 and can be activated and utilized at the discretion of either the trainee or the instructor based on their input to the system. Additionally the clinical scenarios can also activate the various monitors, analyzers and other clinical devices. All three patient simulators are self-contained. They do not require additional devices such as the EKG machine or Blood Pressure Monitor.

### Absolute Mode

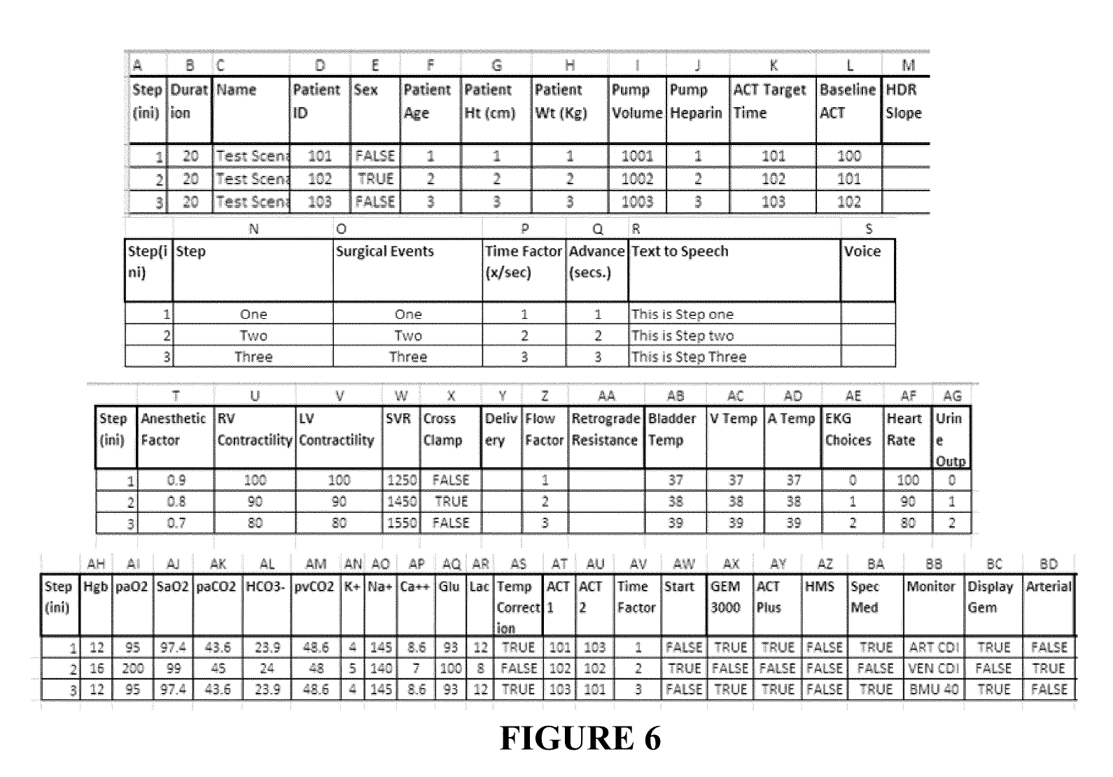

Referring to FIG. 6, a clinical scenario spreadsheet is shown according to one or more embodiments. Clinical Scenarios can be written and loaded into the Simulator as a spreadsheet. Each column represents either a different control from the Controller display or a specific action to be performed. Each row defines a different step (Scenario Steps) that determines all of the settings and variables that define the patient and the patient monitoring choices. Below is a composite view of an actual spreadsheet used to program a clinical scenario composed of three steps illustrating the 56 individual variables that are manipulated by the simulator.

The first three columns define the step number, name and the length of time (duration) that the simulator will wait before advancing to the next step. This information is then displayed on the drop-down table near the middle of the controllers screen (see FIG. 5A) This scenario table along with the Scenario Progress bar and the green and red “GO” and “Stop” buttons below it are controls the operator can use to start and stop the automatic progression, jump to any other step and otherwise monitor the progress of the scenario.

The next five columns define the Patient ID, sex age height and weight. This information will be used by the computer models (algorithms) that will determine many of the physiological parameters and responses of the patient. The next five columns (I-M) are data used to define the “Heparin Sensitivity” of the patient and represent variables used to for the “Heparin Management System” (HMS). The display output for the HMS can be called up by the clinician using a button on the touch screen that will also be printed by the receipt printer. The “Surgical Events”, column O, are entries that can be used to communicate with the clinician to indicate the progress of the surgery. This entry shows up at the top of the “O.R. monitor”. The next two columns, P and Q are used to control the O.R. clock shown at the top left of a monitor. “Time Factor” dictates how fast the O.R. clock will move. For example, with an entry of 10, the O.R. clock will move ahead ten seconds every second. “Advance” is used to force the O.R. clock to jump ahead. The “Text to Speech” and “Voice” columns (R and S) will cause the simulator to talk, using one of three voices as determined by the “Voice” entry. Column T (Anesthetic Factor) allows the operator to adjust the depth of anesthesia for the patient. This will cause a change in the rate of metabolism for the patient that will in turn alter the rate of Oxygen consumption and CO2 production via the metabolic algorithms in the models.

Columns U through W adjust the cardiovascular health of the patient. Manipulations of these variables will show up as changes in the pressure waveforms (and pressure values) shown on the “O.R. monitor”.

Surgical application of the aortic “cross clamp” can be initiated with a true entry in column X, causing the heart to stop ejecting blood and the blood pressure to fall (unless the heart lung machine operator is performing their task appropriately).

Columns Y, Z and AA control variables associated with “Cardioplegia” delivery (anesthetic for the heart). The simulator has flow sensors that will measure the delivery of cardioplegia from the heart lung machine. Column Y dictates whether the cardioplegia will enter the heart in an antegrade or retrograde (against the normal blood flow pattern). The flow factor (column Z) dictates the speed to which the heart will respond to the delivery. As cardioplegia is delivered, the EKG pattern will automatically cycle through 12 individual patterns ranging from a normal pattern to a flat line depending on the rate of the cardioplegia delivery. If the cardioplegia is being delivered retrograde, the CVP pressure trace (dashed bottom line in FIG. 4) will automatically convert to a display of “coronary sinus pressure” indicating the driving pressure of the cardioplegia. The “Retrograde Resistance” column (AA) can then be used to indicate the resistance to flow, affecting the pressure displayed on the monitor.

The patient's bladder temperature and arterial and venous blood temperatures are dictated by columns AB, AC and AD. Which of the twelve EKG patterns is displayed and the patient's heart rate are set by entries in columns AE and AF. The patient's accumulated urine output is control by column AG and the results are continuously displayed on the O.R. monitor. The next ten columns (AH-AR) represent lab results for various blood values. Some of these values are displayed on the on-line blood monitors. Some are used in the computer models to calculate secondary variables and some are displayed in the lab results print-out

The activated clotting time (ACT) analyzer is controlled by the next four columns (AT-AW). This ACT analyzer becomes visible by a true condition in column AY. ACT 1 and ACT 2 (columns AT and AU) dictate the resultant clotting time after the analysis is complete. The time factor allows the machine to advance faster than real time to allow it to move to completion without the need to wait the entire time for the result. A TRUE value in the start column (AW) will initiate the analysis.

The remaining nine columns determine which of the available monitors and analyzers will be visible on the O.R. monitor screen.

An entry of ‘true’ in column AX and BC will display the blood analyzer strip showing the results of the blood gas analysis. An entry of ‘false’ in the last column (BD) will display the results of the venous blood gas and ‘true’ will display the results for arterial blood. These results can be printed out on the receipt printer if the clinician presses the red button labeled ‘call for blood gas’ shown on the O.R. monitor.

In addition to pausing and restarting the scenario, the controller can change any one of the functions represented by columns in the programming spreadsheet. Each of these functions is represented by an individual control on the Controllers Display (see FIG. 5A).

The controller also has the option of saving pertinent patient data in an “electronic medical record” of the case. Data relevant to the case can be stored in a separate spreadsheet that time stamps the data.

Comments from the controller can be entered during the case by typing into a data entry box in the middle of the Controllers Display and hitting the “Submit” button (see FIG. 5A).

### Calculated Mode

A patient monitor/delivery device can be used in “Calculated Mode” (not shown) according to one or more embodiments. The major difference between the “Absolute Mode” and the “Calculated Mode” is that the “Calculated Mode” provides the ability for the simulator to calculate various blood gas parameters based on the actions of the clinical operator instead of dictating the values as described above. In the case of the Calculated Mode, a ventilator option is included on the patient monitor/delivery device.

In calculated mode, the clinician can make the patient ventilator visible on the O.R. monitor screen (highlighted with the red circle) by touching the lower green button off to the far right labeled “Ventilator”. “Pressure Mode” ventilation or “Volume Mode” ventilator options can be selected. The ventilator is operated by first touching the knob on the ventilator to activate it, and then turning the large thumb wheel in the far left bottom corner to adjust the parameter accordingly. All of the blood gases including pH and venous O2 saturation will respond accordingly based on the patient's size and temperature by means of the algorithm models in the simulator. In addition, variables for ventilating the artificial lung in either the heart lung machine or ECMO machine can be adjusted by means of the “Oxygenator Controls” (highlighted by the yellow circle) made visible by the upper green button to the far right. Changes in the “Oxy Sweep” (upper control) or “Oxygenator FIO2 (middle blue knob) will also change the patient's blood gases and pH depending on the blood flow rate being delivered by the heart lung machine or ECMO machine. Both the ventilator and machine oxygenator are working concomitantly, allowing the operator to adjust each independently. This makes it possible to challenge the clinician to determine whether the patient is well enough to allow termination of the extracorporeal blood support and therefore transition to the ventilator alone.

The spreadsheet used to load the scenario for the “Calculated Mode” has some differences from that described above for the “Absolute Mode”. For the “Calculated Mode”, the first difference is the inclusion of parameters describing the patient's lung disease. Dead space (S), Pulmonary Shunt Fraction (V), Airway Resistance (W) and Pulmonary Compliance (X), are variables that characterize the degree of lung disease suffered by the patient. Changes in any one of these parameters require a specific change in the adjustment of the ventilator and will have an effect on the blood gas results. Likewise, Oxygenator Shunt (T) defines the effectiveness of the artificial lung and together with Cannula Recirculation (U) will determine the impact of the heart lung or ECMO machine.

Another major difference in scenario parameters is the lack of any blood gases in the “Calculated Mode” scenario since these are all being calculated. Likewise, instead of dictating the patient's bladder temperature, the “Calculated Mode” relies on the temperature probe in the simulator reservoir for the value used in the algorithms and displayed on the O.R. monitor screen.

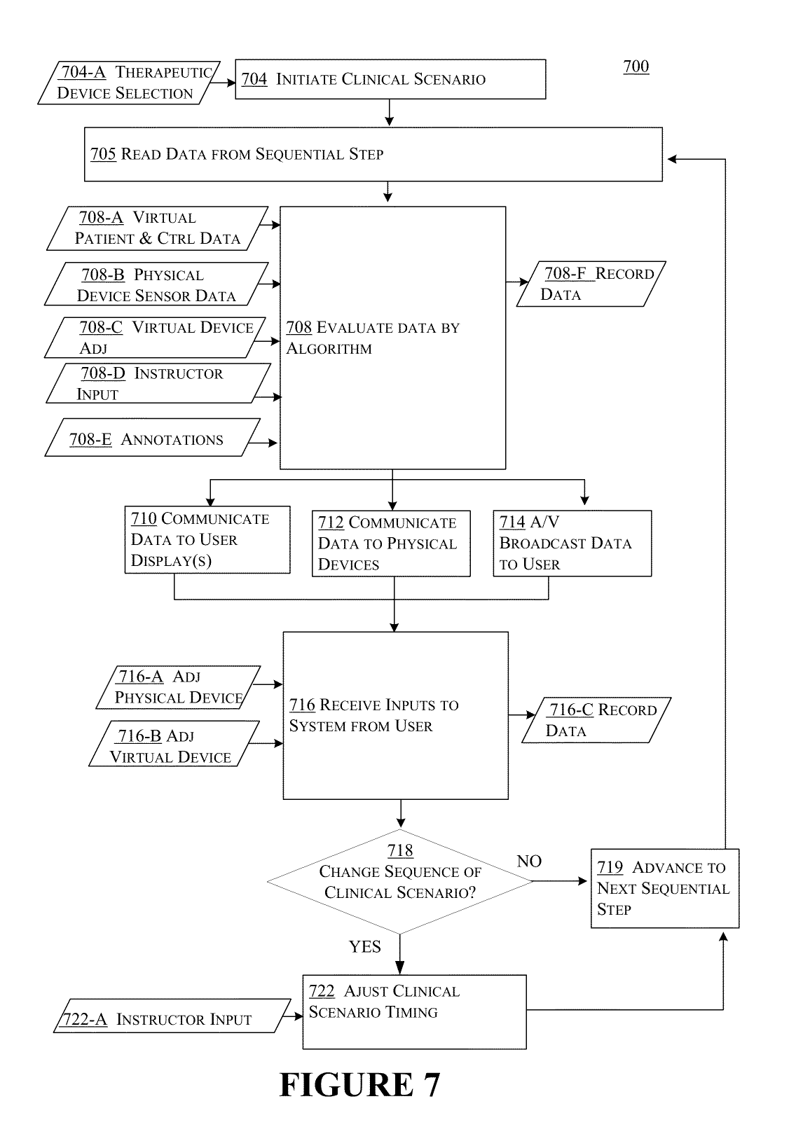

Referring now to FIG. 7, a flowchart 700 of a process simulating a patient interaction with a therapeutic machine is shown, according to one or more embodiments. Flowchart 700 is implemented on processor 202 and memory 206 of computing device 102 with relevant data communicated between patient module 101, patient monitor/delivery device 108, and computing device 102, as appropriate for the protocol. Flowchart 700 initiates a clinical scenario in operation 704, per input from instructor or clinician calling up an executable file from computing device 102 of FIG. 1 and providing a therapeutic device selection input 704-A, e.g., an ECMO machine. If the simulation system 100 is operated in real mode, then an identified therapeutic device from the therapeutic device option set 103 is coupled to the patient module 101. Else, if the simulation system 100 is operated in simulation mode, the identified therapeutic device can either be coupled to the patient module 101, or not, since any physical device inputs are ignored, and the entire clinical scenario is executed in a virtual mode.

In operation 705, data is read from a sequential step of the electronic file, i.e., from all relevant fields, such as columns A through BD of a spreadsheet file, as described in the prior FIG. 6. Operation 708 evaluates the data from the spreadsheet for the given sequential step. For example, spreadsheet columns relating sex, age, height, weight, body fluid and organ temperatures, urine output, and degree of lung disease, or other pathology will be evaluated by one or more algorithms 262 of FIG. 2B operating in the clinical scenario module 252, which is executed the processor 202 and memory 206 of computing device 102. Operation 708 also accepts input from many different sources, such as virtual patient and control data input 708-A, which is data the algorithm synthesizes internally from spreadsheet data that was just read. For example reading a patient data on heart conditions in one algorithm can then provide input to another algorithm, such as a cardio algorithm, that internally degrades a baseline related heart metric because of the given patient pathological conditions. Another input to the evaluation operation 708 is physical device sensor data 708-B, e.g. pressure and flow data sensed by ucontroller 305 via A/D 303 in patient module 101 and communicated to computing device 102 via link 130, as shown in FIGS. 1 and 3. For example, while a given patient module might appear properly coupled to an ECMO machine for an ECMO simulation, the actual initiation of a transfer of fluid from patient module 101 to ECMO machine 112, might expose a flaw in the physical coupling of the tubing. This might lead to a change in measured performance, such as a miscoupled port having a leak and thereby resulting in a drop of measured pressure 320 on input line 222 of FIG. 3A that is then communicated to algorithm evaluation operation 708. Virtual device adjustment input 708-C can also be input to operation 708. This input can arise from an adjustment by the clinician ab initio or preemptively, i.e., before the simulation finishes evaluating the sequential step in the simulation system 100. Another input is instructor input 708-D, which can implement a wide range of control adjustments or timing, as described in FIG. 5A. Finally, annotations input 708-E can be input to the system by instructor or clinician for noteworthy conditions, reactions, or performances. An output of recording data 708-F can record any time-sampled rate of physical and virtual data, ranging from the equipment settings, to the simulated patent vital signs, along with annotations to capture the overall performance.

As the algorithms evaluate the input data provided in operation 708, that resulting output data is communicated to user displays in operation 710. For example, patient physiology and virtual control information, as discussed in FIG. 5A, can be communicated to user display(s), e.g., to instructor on computing device 102, and to clinician via patient monitor/delivery device 108, of FIG. 1. The clinician might receive data such as patient physiological conditions and optional simulated (virtual) physiological systems such as drug administration, (together “components”). The instructor display receives a more complete suite of information for control and testing purposes.

In parallel to information being passed to user displays, other information from the algorithm evaluation operation 708 is communicated to physical devices in operation 712. Algorithm outputs are provided on electrical, optical, etc. lines 130 to physical control devices in patient module 101, e.g., stepper valves 330, 332, 334, B.P. pump 318, etc. to set the simulated patient scenario for the clinician. Thus, if the patient being simulated by the patient module 101 is an overweight adult male with acute arterial sclerosis, a signal can be communicated to stepper valve 334 that will reduce its internal diameter significantly from what would otherwise be a normal diameter size for a healthy patient. Many other application specific scenarios can be presented in the data of the spreadsheet.

Another parallel branch of output from the algorithm evaluation operation 708, is operation 714 of communicating audio/visual (A/V) broadcast data to the user. For example, a text to speech instruction can be executed on a speaker system of patient monitor/delivery device 108 to communicate a statement, order, question, or other interaction with the clinician/operator. In another example, a video clip of a surgeon head-cam can begin playing at the time a step for initiating the HLM is given. Alternatively, a video or still picture of a clinical or diagnostic test, such as an angiogram, requested by the clinical scenario can be brought up.

Thus, with the multiple parallel branches for data output from the algorithmic evaluation operation 708, the system provides a near real-time experience for the clinician with many changes occurring at once. For operations or conditions that are meant to be serial, data can be provided for in subsequent steps in the spreadsheet. Alternatively, only one variable can be changed at a time, with all other variable in the spreadsheet remaining constant across multiple steps.

As the algorithm evaluates the data, and as the patient module 101 and the therapeutic devices begin to react, the simulation system will receive inputs in operation 716 from a user of the simulation system who has evaluated the situation and is reacting by changing settings on physical control devices or virtual control devices, as inputs 716-A and 716-B, respectively. Recording data operation 716-C can electronically store the inputs 716-A and 716-B along with the patient's physiological data, both from physical sensors and from virtually simulated vital signs for subsequent analysis and grading of the clinician.

In operation 718, an inquiry determines whether a change in the sequence of the clinical scenario is desired. If no change is desired, then operation 719 advances the clinical scenario to the next sequential step in the spreadsheet, and the flowchart 700 repeats, starting at operation 705 of reading of data from that next sequential step. If, however, the instructor does wish to adjust the timing of the clinical scenario, and then input 722-A from instructor can change clinical scenario timing in operation 722. The timing can be halted, accelerated, stepped forward in time, slowed down, sped up, or the clinical scenario could be canceled. This operation allows an instructor to input commands via instructor display 104 to processor 202 in computing device 102 for altering the timing. For example, an instructor may wish to advance to a step halfway through a given clinical scenario for focusing a clinician on a discrete operation. If the clinical scenario is not canceled by the instructor, then after operation, the clinical scenario advances to the next sequential step in the spreadsheet, and flowchart 700 repasts.

Once a clinical scenario has been completed or stopped, a different clinical scenario may be uploaded in software, and an entirely different scenario tested on the clinician. Alternatively, after a given clinical scenario has been completed or stopped, a therapeutic device coupled to the patient module 101 can be changed to a different therapeutic device in just minutes, and another clinical scenario for the new therapeutic device can be run on the same patient module 101 and computing device 102 equipment. Alternatively, the same patient physiological data can be reused on the new therapeutic machine, and thus offer a closely timed comparison of how different therapeutic machines will result in different vital signs and different long-term clinical course results.

### Alternative Embodiments

References to methods, operations, processes, systems, and apparatuses disclosed herein that are implementable in any means for achieving various aspects, and may be executed in a form of a machine-readable medium, e.g., computer readable medium, embodying a set of instructions that, when executed by a machine such as a processor in a computer, server, etc. cause the machine to perform any of the operations or functions disclosed herein. Functions or operations may include receiving, measuring, communicating, altering, adjusting, transmitting, and the like.

The term “machine-readable” medium includes any medium that is capable of storing, encoding, and/or carrying a set of instructions for execution by the computer or machine and that causes the computer or machine to perform any one or more of the methodologies of the various embodiments. The “machine-readable medium” shall accordingly be taken to include, but not limited to, solid-state memories, optical and magnetic media, compact disc and any other storage device that can retain or store the instructions and information, e.g., only non-transitory tangible medium. The present disclosure is capable of implementing methods and processes described herein using transitory signals as well, e.g., electrical, optical, and other signals in any format and protocol that convey the instructions, algorithms, etc. to implement the present processes and methods.

Exemplary computing systems, such as a personal computer, minicomputer, mainframe, server, etc. that are capable of executing instructions to accomplish any of the functions described herein include components such as a processor, e.g., single or multi-processor core, for processing data and instructions, coupled to memory for storing information, data, and instructions, where the memory can be computer usable volatile memory, e.g. random access memory (RAM), and/or computer usable non-volatile memory, e.g. read only memory (ROM), and/or data storage, e.g., a magnetic or optical disk and disk drive). Computing system also includes optional inputs, such as alphanumeric input device including alphanumeric and function keys, or cursor control device for communicating user input information and command selections to processor, an optional display device coupled to bus for displaying information, an optional input/output (I/O) device for coupling system with external entities, such as a modem for enabling wired or wireless communications between system and an external network such as, but not limited to, the Internet. Coupling of components can be accomplished by any method that communicates information, e.g., wired or wireless connections, electrical or optical, address/data bus or lines, etc.

The computing system is only one example of a suitable computing environment and is not intended to suggest any limitation as to the scope of use or functionality of the present technology. Neither should the computing environment be interpreted as having any dependency or requirement relating to any one or combination of components illustrated in the exemplary computing system. The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

Methods and operations described herein can be in different sequences than the exemplary ones described herein, e.g., in a different order. Thus, one or more additional new operations may be inserted within the existing operations or one or more operations may be abbreviated or eliminated, according to a given application, so long as substantially the same function, way and result is obtained

Although the present embodiments have been described with reference to specific example embodiments, it will be evident that various modifications and changes may be made to these embodiments without departing from the broader spirit and scope of the various embodiments.

The foregoing descriptions of specific embodiments of the present disclosure have been presented for purposes of illustration and description. They are not intended to be exhaustive or to limit the invention to the precise forms disclosed. Many modifications and variations are possible in light of the above teaching without departing from the broader spirit and scope of the various embodiments. The embodiments were chosen and described in order to explain the principles of the invention and its practical application best, to enable others skilled in the art to best utilize the invention and various embodiments with various modifications as are suited to the particular use contemplated. It is intended that the scope of the invention be defined by the Claims appended hereto and their equivalents.

I/We claim:

1. A medical simulation system, comprising:
a patient module representing a human body, the patient module comprising:
a fluid circuit coupleable to an extracorporeal membrane oxygenator (ECMO) machine for interactively communicating a fluid therebetween;
a patient display/delivery device; and
a computing device coupled to the patient module and the patient display/delivery device, wherein the computing device includes a processor and a memory coupled to each other; and wherein:
the computing device interacts with the patient module to simulate vital signs of the patient module as the patient module interacts with the ECMO machine; and
the computing device receives physical data from the patient module and provides instructions to the patient module to implement a clinical scenario.

2. The medical simulation system of claim 1 wherein:
the patient module further comprises:
an input port disposed in the fluid circuit;
an output port disposed in the fluid circuit;
at least one fluid sensor disposed in the fluid circuit for measuring a fluid property; and
at least one control device disposed in the fluid circuit for altering a fluid performance in the fluid circuit; and
the patient display/delivery device displays at least a portion of the clinical scenario for an operator, and is configured to receive an instruction from the operator to adjust at least one virtual control of the ECMO machine; and
the computing device further comprises:
an instructor display coupled to the processor, the instructor display for displaying details of the clinical scenario; and wherein:
the computing device is coupled to the patient module via an analog-to-digital converter module.

3. The medical simulation system of claim 2 wherein the fluid circuit further comprises:
the output port is coupled to an output conduit in the patient module, the output port for outputting fluid from the patient module to the ECMO machine; and
the input port is coupled to an input conduit in the patient module, the input port for receiving fluid from the ECMO machine to the patient module; and wherein:
the output port is configured as a venous drain;
the input port is selectively configured as a venous return or an arterial return to the patient module; and wherein:
the fluid circuit has a same routing path in the patient module regardless of whether the input port is configured as the venous return or the arterial return.

4. The medical simulation system of claim 1 wherein the means for varying the cannula resistance is a stepper motor proportioning valve having a selectively variable internal diameter that varies a flow rate of the fluid over a range a neonate to for a range for an adult, as instructed by the computing device based upon the clinical scenario.

5. The medical simulation system of claim 2 wherein the processor and memory are configured to implement a process of:
receiving the clinical scenario selection that is selected via an interface to the computing device;
receiving a physical data from the at least one fluid sensor in the patient module, wherein the data from the at least one fluid sensor measures any changes in the fluid received from the ECMO machine in response to a change the operator made to the ECMO machine;
calculating at least one virtual fluid data, via an algorithm, for the patient module based on at least one of the clinical scenario, and the physical data from the at least one fluid sensor; and
the at least one virtual fluid data is one of a central venous pressure (CVP), a coronary sinus pressure (CSP), a pulmonary pressure, an arterial pressure, arterial flow rate, and venous flow rate.

6. The medical simulation system of claim 5 wherein the processor and memory are further configured to implement a process of:
receiving an optional input from the operator, via a patient display/delivery device coupled to the computing device, to select one of a virtual drug dose, a virtual lab test, a change to a virtual control presented by the clinical scenario; and
receiving an optional input from an instructor, via an instructor interface, to modify one of a virtual control data.

7. The medical simulation system of claim 6 wherein the processor and memory are further configured to implement a process of:
calculating, via the computing device, a virtual data for the patient module, including at least one of an immediate vital sign and a long-term clinical course, in at least one of a cardiovascular system, a respiratory system, a hematological system, and a renal system, by implementing at least one algorithm that evaluates at least one of the clinical scenario, the physical data from at least one sensor, the change to the virtual control by the operator, the at least one virtual fluid pressure, and the optional input from the instructor;
displaying one or more of the immediate vital sign and a long-term clinical course on at least one of the patient display/delivery device and the GUI; and
optionally generating a control signal to the at least one control device in the patient module based on the algorithm and the clinical scenario.

8. The medical simulation system of claim 6 wherein the patient module further includes:
a microcontroller and a memory coupled to the at least one sensor and the at least one control device; and wherein:
the microcontroller and memory implement at least one algorithm that simulate a reflexive action of the patient module based on one or more of the at least one fluid sensor and the at least one control device in the patient module; and
the microcontroller can operate independently of the computing device.

9. The medical simulation system of claim 11 wherein:
the virtual data virtual data generated from the at least one algorithm for the patient module includes at least one of a central venous pressure (CVP), a coronary sinus pressure (CSP), a cardiac output, a mixed venous O2 saturation level, an active clotting time (ACT), a heparin resistance, an elevated of blood pressure level, a heart failure mode, a pathology condition, EKG pattern, oxygenation delivery rate and CO2 removal rate, a blood clotting property, and concurrent blood gas levels for of pre-oxygenator, post-oxygenator, and arterial and venous blood categories.

10. The medical simulation system of claim 5 wherein:
the computing device programmably implements the clinical scenario;
the clinical scenario comprises a plurality of sequential steps that are automatically implemented;
each of the sequential steps contains a time value specifying the duration of the sequentially timed step, or contains a condition precedent specifying a condition that must be satisfied before advancing to a next step;
at least one of the sequential steps contains a value for controlling the at least one control device in the patient module; and
at least one of the sequential steps contains physiological data of a body being simulated.

11. The medical simulation system of claim 10 wherein:
the plurality of steps is received on an electronic file with field-separated columns for data entries, and with at least one row entry for each sequential step;
the clinical scenario can be interrupted by an instructor input at an end of a given step and pause or cancel the clinical scenario;
an annotation can be entered, via the instructor display or the patient display, into the electronic file for the clinical scenario at a given step to document a performance of the operator; and
at least one of the sequential steps contains an audio/visual file, for a surgical operation or a diagnostic treatment information for the simulated patient; and
the audio/visual file is one of a text-to-voice script for a verbal communication to the operator, a video clip of a surgical operation, and a video or image of a clinical test requested in the clinical scenario.

12. The medical simulation system of claim 1 wherein:
the computing device is selectable to operate in a real mode or in a simulation mode;
the real mode interacts with the patient module to evaluate the at least one fluid property measured and to provide a signal to the at least one control device; and
the simulated mode provides no interaction with the patient module and calculates all data for a simulated patient.

13. A medical simulation system, comprising:
a patient module representing a human body, the patient module comprising:
a fluid circuit coupleable to at least one of a plurality of different types of therapeutic machines for interactively communicating fluid therebetween; and
a computing device coupled to the patient module, wherein the computing device comprising a processor coupled with a memory; and wherein:
the computing device interacts with the patient module to simulate the patient undergoing therapy with the at least one of the plurality of types of therapeutic machines;
the plurality of different types of therapeutic machines is one of an extracorporeal membrane oxygenation (ECMO) machine, and a heart lung machine (HLM);
the at least one clinical scenario is selected based on an identified therapeutic machine chosen from the plurality of different types of therapeutic machines for; and
no hardware changes are required to the patient module for any of the plurality of different types of therapeutic machines;

14. The medical simulation system of claim 13 wherein the at least one of the plurality of types of therapeutic machines is one of:
a ventricular assist device (VAD);
a hypothermic intraperitoneal chemotherapy (HIPEC);
an emergency cardiac life support (ECLS);
a heater/cooler machine (HCM); and
an aortic balloon pump.

15. The medical simulation system of claim 14 wherein the patient module further comprises:
at least one fluid sensor disposed in the fluid circuit for measuring a fluid property;
at least one control device for altering a fluid performance; and
at least one port coupled to the fluid sensor; and wherein:
the at least one fluid sensor measures a fluid property that is common among all of the plurality of types of therapeutic machines;
the at least one control device controls a fluid performance that is common among all the plurality of types of therapeutic machines;
the computing device algorithmically generates at least one virtual fluid property of the patient module that is needed by the clinical scenario for identified therapeutic machine;
the computing device displays the at least one virtual fluid property on at least one of a patient display/delivery device used by the operator, and an instructor display of the computing device used by an instructor; and
the computing device displays a virtual control, on the instructor display, having a selectable parameter for the identified therapeutic machine.

16. The medical simulation system of claim 15 wherein the fluid circuit further comprises:
at least one output port coupled to an output conduit in the patient module, the at least one output port for outputting fluid from the patient module to the identified therapeutic machine; and
at least one input port coupled to an input conduit in the patient module, the input port for receiving fluid from the identified therapeutic machine; and wherein:
the output port is configured as a venous drain of the patient; and
the input port is selectively configured to as a venous return or an arterial return of the patient module as configured by the computing device according to the clinical scenario chosen and according to the identified therapeutic machine.

17. The medical simulation system of claim 16 wherein:
the fluid property that is common among all of the plurality of types of therapeutic machines includes at least one of an input fluid pressure that represents either an arterial return pressure or a venous return pressure, an output fluid pressure that represents a venous drain pressure, and a flow rate of fluid on the input conduit; and
the at least one control device that is common among all the plurality of types of therapeutic machines includes at least one of a diameter of the input conduit that represents a diameter of a cannula used for the input, and a diameter of the output conduit representing a cannula used for an output.

18. The medical simulation system of claim 15 wherein the processor and memory are configured to implement a process of:
receiving the clinical scenario selected via an interface to the computing device;
receiving a physical data from the at least one sensor in the patient module, wherein the data from the at least one sensor measures any changes in the fluid received from the identified therapeutic machine in response to any change the operator made to the identified therapeutic machine;
calculating at least one virtual fluid data, via an algorithm, for the patient module based on at least one of the clinical scenario, and the physical data from the at least one fluid sensor; and
the at least one virtual fluid data is one of a central venous pressure (CVP), a coronary sinus pressure (CSP),a pulmonary pressure, an arterial pressure, arterial flow rate, and venous flow rate.

19. The medical simulation system of claim 17 wherein the processor and memory are further configured to implement a process of:
calculating, via the computing device, a virtual data for the patient module, including at least one of an immediate vital sign and a long-term clinical course of the patient in at least one of a cardiovascular system, a respiratory system, a hematological system, and a renal system, via an algorithm that evaluates at least one of the clinical scenario, the data from at least one sensor, the change to the virtual control by the operator, and the optional input from the instructor;
displaying on at least one of the patient display/delivery device and the GUI, the at least one of an immediate vital sign and a long-term clinical course, and any change to the virtual control;
optionally generating a control signal to the at least one control device in the patient module based on the algorithm and the clinical scenario; and
optionally generating a control signal to the at least one virtual control simulated by the computing device, based on the algorithm and the clinical scenario.

20. The medical simulation system of claim 19 wherein:
receiving an input from the operator via a patient display/delivery device coupled to the computing device, wherein the input from the operator is for any one of a drug dose, and a change to the virtual control required by the clinical scenario or input by the operator on the patient display; and
receiving an optional input from an instructor, via an instructor interface, to modify one of a virtual control data.

21. The medical simulation system of claim 18 wherein:
a selection is made by the operator to add another one of the plurality of types of therapeutic machines, as an additional therapeutic machine, to the simulation system;
the computing device simulates at least another one of the plurality of types of therapeutic machines as a virtual therapeutic machine that is algorithmically interfaced with the identified one of the plurality of types of therapeutic machines;
the virtual therapeutic machine algorithmically interacts with the identified therapeutic machine that is coupled to the patient module;
the computing device simulates at least one virtual control feature of the virtual therapeutic machine; and
the computing device modifies at least one of an immediate vital sign and a long-term clinical course of the patient based on the operator input to the virtual control feature of the virtual therapeutic machine.

22. The medical simulation system of claim 21 wherein:
the identified therapeutic machine is the ECMO machine;
the additional therapeutic machine is a VAD machine;
the data from the at least one sensor in the patient module measures a change in the flow rate of the fluid received from the ECMO machines that results from a change in the pump flow rate setting made by the operator; and
the virtual control change made by the operator on the patient display/delivery device is a change in the ECMO oxygenation rate that is algorithmically simulated by the computing device and displayed on the patient display/delivery device.

23. A method of programmably implementing one of a plurality of clinical scenario in a simulation system having a patient module coupled to a computing device and to one of a plurality of therapeutic devices, the method comprising:
receiving an input identifying one of the plurality of therapeutic devices as an identified therapeutic device to which the patient module is coupled for the clinical scenario;
receiving an input identifying one of the plurality of clinical scenarios as an identified clinical scenario to be evaluated on the identified therapeutic device;
receiving a sequential step of data from the identified clinical scenario;
reading a data value, contained in the sequential step of data, for at least one control device in the patient module;
reading a data value, contained in the sequential step of data, for at least one physiological condition for the patient module; and
reading a data value, contained in the sequential step of data, for at least one virtual control in the identified therapeutic device for the patient module;
receiving an optional input from an operator, via a patient display/delivery device, of a setting of a virtual variable of the identified therapeutic machine;
sampling a physical data value from the at least one fluid sensor in the patient module;
calculating, via the computing device, a virtual data for the patient module, including at least one of an immediate vital sign and a long-term clinical course of the patient module, in at least one of a cardiovascular system, a respiratory system, a hematological system, and a renal system, by implementing at least one algorithm that evaluates the identified clinical scenario, the physical data from at least one sensor, and the optional input from the operator setting the virtual variable; and wherein:
the plurality of therapeutic machines includes an extracorporeal membrane oxygenation (ECMO) machine, and a heart lung machine (HLM); and
no hardware changes to the patient module are required for running any one of the plurality of therapeutic machines.

24. The method of claim 23 further comprising:
calculating at least one virtual fluid data, via an algorithm, for the patient module based on the identified clinical scenario, and the physical data from the at least one fluid sensor; and
the calculating operation additionally evaluates the at least one virtual fluid pressure in the algorithm.

25. The method of claim 23 further comprising:
receiving an additional optional input from the operator, via a patient display/delivery device coupled to the computing device, to select one of a virtual drug dose, a virtual lab test, a change to a virtual control presented by the clinical scenario;
receiving an optional input from an instructor, via an instructor interface, to modify one of a virtual control data; and
the calculating operation additionally evaluates the additional optional input from the operator and the optional input from the instructor in the algorithm.

26. The method of claim 23 further comprising:
receiving a time value, contained in the sequential step, that specifies a duration of the sequential step, or contains a condition precedent specifying a condition that must be satisfied before advancing to a next step;
automatically advancing the clinical scenario to a next step upon expiration of the time value or satisfaction of the condition precedent; and
receiving an optional input from the instructor for implementing one of an instruction to pause, cancel, or advance the clinical scenario, a modification of a virtual variable, and an override of a vital sign or a long-term clinical course.

27. The method of claim 23 further comprising:
displaying, on one of a patient monitor/delivery device and an instructor display, one of a changed vital sign, a changed virtual value selection, and a new diagnostic tool;
outputting a control signal to the at least one control device in the patient module based on the calculating operation;
communicating at least one of an audio and a video file identified in a sequential step, for an instruction or a related-procedure for the given sequential step of the clinical scenario, including at least one of a text-to-voice script, a head-cam video clip of a surgeon's view of the operation, and a video or picture of a diagnostic test result (angiogram); and
optionally storing, at a given sampling resolution, one or more of the control values and virtual control choices by the operator and the resulting algorithmically calculated data.

28. The method of claim 23 further comprising:
adjusting, reflexively, at least one control variable in the patient module, via a microcontroller disposed in the patient module, based on the at least one data value measured in the patient module; and wherein:
the adjusting operation in the patient module is performed independently and without any input from the computing device.

29. The method of claim 23 further comprising:
receiving an input to operate the simulation system in a real mode or in a simulation mode; and wherein:
the real mode interacts with the patient module to evaluate the at least one fluid property measured and to provide a signal to the east one control device disposed; and
the simulated mode provides no interaction with the patient module and calculates all data for patient.
